(19) United States
(12) Patent Application Publication
(10) Pub. No.: US 2024/0283874 A1
(43) Pub. Date: Aug. 22, 2024

(54) INFORMATION PROCESSING APPARATUS, INFORMATION PROCESSING SYSTEM, INFORMATION PROCESSING METHOD, AND RECORDING MEDIUM

(71) Applicants: Taroh Futatsuya, Kanagawa (JP); Masatoshi Yanase, Kanagawa (JP)

(72) Inventors: Taroh Futatsuya, Kanagawa (JP); Masatoshi Yanase, Kanagawa (JP)

(73) Assignee: Ricoh Company, Ltd., Tokyo (JP)

(21) Appl. No.: 18/414,817

(22) Filed: Jan. 17, 2024

(30) Foreign Application Priority Data
Feb. 17, 2023 (JP) 2023-023062

(51) Int. Cl. H04N 1/00; G06F 3/0481

(52) U.S. Cl. CPC H04N 1/00076; G06F 3/0481; H04N 2201/0094

(57) ABSTRACT

An information processing apparatus includes circuitry that disables an operation on a screen displayed on a display, and switches display of the screen in accordance with an urgency level of an error in response to occurrence of the error after the operation is disabled.

### CROSS-REFERENCE TO RELATED APPLICATIONS

This patent application is based on and claims priority pursuant to 35 U.S.C. § 119(a) to Japanese Patent Application No. 2023-023062, filed on Feb. 17, 2023, in the Japan Patent Office, the entire disclosure of which is hereby incorporated by reference herein.

### BACKGROUND

### Technical Field

The present disclosure relates to an information processing apparatus, an information processing system, an information processing method, and a recording medium.

### Related Art

Some information processing apparatuses such as smartphones and tablet terminals and some image processing apparatuses such as multi-function peripherals (MFP) include an operation panel (touch panel) with a screen to be touched to input various kinds of information.

When a touch panel is cleaned or the like, an operation on the screen is to be disabled so that various kinds of information are not input.

In the related art, techniques of disabling an operation on a screen include a technique of, in response to an input from a touch panel located at an operation-disabling-information display portion, disabling an input on the touch panel and changing a background color of the screen to a black-based color.

### SUMMARY

According to an embodiment of the present disclosure, an information processing apparatus includes circuitry. The circuitry disables an operation on a screen displayed on a display, and switches display of the screen in accordance with an urgency level of an error in response to occurrence of the error after the operation is disabled.

According to another embodiment of the present disclosure, an information processing system includes a display and circuitry. The display displays a screen. The circuitry disables an operation on a screen displayed on the display, and switches display of the screen in accordance with an urgency level of an error in response to occurrence of the error after the operation is disabled.

According to another embodiment of the present disclosure, an information processing method includes disabling an operation on a screen displayed on a display, and switching display of the screen in accordance with an urgency level of an error in response to occurrence of the error after the operation is disabled.

According to another embodiment of the present disclosure, a non-transitory recording medium stores a plurality of instructions which, when executed by one or more processors, causes the processors to perform an information processing method. The information processing method includes disabling an operation on a screen displayed on a display, and switching display of the screen in accordance with an urgency level of an error in response to occurrence of the error after the operation is disabled.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a hardware configuration of an MFP which is an information processing apparatus according to an embodiment of the present disclosure;

FIG. 2 is a diagram illustrating an example of a software configuration of the MFP;

FIG. 3 is a block diagram illustrating a first example of a functional configuration of the MFP;

FIG. 4 is a sequence diagram illustrating a first example of a process to be performed in response to occurrence of an error after an operation on a screen is disabled;

FIG. 5 is a table for describing an urgency level of the error;

FIG. 6 is a flowchart illustrating an example of a process of making a predetermined screen transparent to permit a touch on an underlying screen in the case where the urgency level of the error is high;

FIG. 7 is a diagram illustrating an example in which the predetermined screen is arranged over an error dialog;

FIG. 8 is a diagram illustrating an example in which the predetermined screen is made transparent;

FIG. 9 is a block diagram illustrating a second example of the functional configuration of the MFP;

FIG. 10 is a sequence diagram illustrating a second example of the process to be performed in response to occurrence of an error after an operation on a screen is disabled;

FIG. 11 is a table for describing content of settings settable by a user; and

FIG. 12 is a diagram illustrating an example of a configuration of an information processing system according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

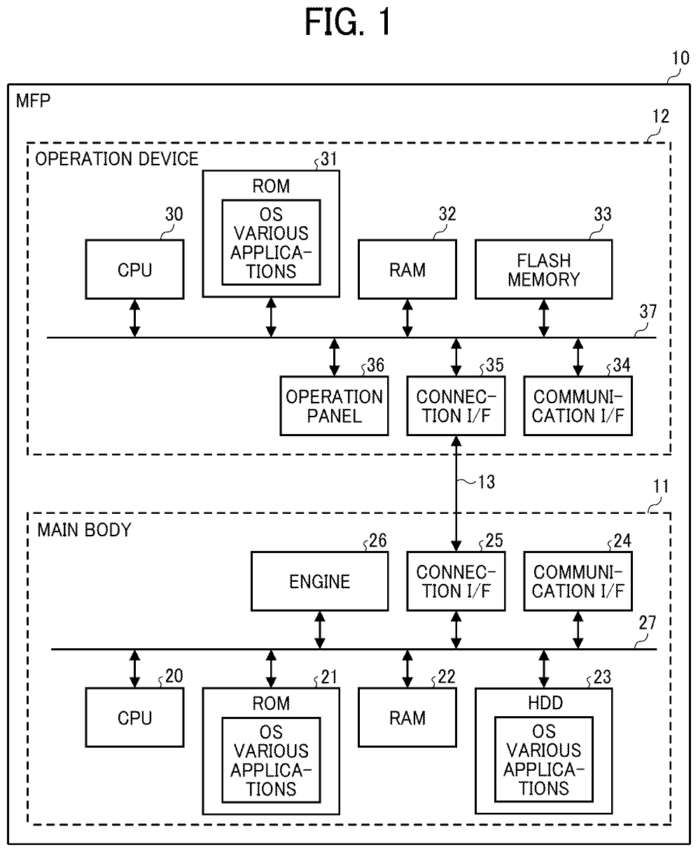

FIG. 1 is a diagram illustrating an example of a hardware configuration of an MFP which is an information processing apparatus according to an embodiment of the present disclosure. Note that the information processing apparatus may be any apparatus that includes an operation panel (touch panel) with a screen to be operated to perform selection of a function, input of information, or the like. The information processing apparatus is not limited to an image processing apparatus such as a printer or an MFP and may be a smartphone, a tablet personal computer (PC), a notebook PC, a personal digital assistant (PDA), a game machine, an interactive whiteboard (IWB: a whiteboard that enables mutual communication and has an electronic whiteboard function), an image-capturing device, a medical device, an industrial machine, a smart appliance, an automobile (connected car), or the like.

An MFP 10 includes a main body 11 that implements various functions such as a copy function, a scanner function, a fax function, and a printer function, and an operation device 12 that receives an input corresponding to an operation by an operator (user). The main body 11 and the operation device 12 are connected to each other through a dedicated communication channel 13. The connection may be wired or wireless. The standard to be used for the connection may be any standard. In one embodiment, the standard to be used for the connection is, for example, the Universal Serial Bus (USB).

The main body 11 includes a central processing unit (CPU) 20, a read-only memory (ROM) 21, a random access memory (RAM) 22, a hard disk drive (HDD) 23, a communication interface (I/F) 24, a connection I/F 25, and an engine 26. The components such as the CPU 20 are connected to one another through a bus 27.

The CPU 20 controls operations of the entire main body 11 and implements the aforementioned various functions such as the copy function, the scanner function, the fax function, and the printer function. The ROM 21 or the HDD 23 stores programs with which the CPU 20 implements the aforementioned various functions, an operating system (OS) which is basic software to run these programs, and so on.

The RAM 22 provides a work area for the CPU 20. Thus, the CPU 20 reads the programs or the like stored in the ROM 21 or the HDD 23 to the RAM 22 and executes the programs to implement the aforementioned various functions.

The communication I/F 24 receives print data and transmits read document data via a network. The connection I/F 25 is an interface for connection to the communication channel 13.

The engine 26 is hardware that performs general-purpose information processing and non-communication processing for implementing image processing functions such as the copy function, the scanner function, the fax function, and the printer function.

In response to the engine 26 performing a process, the main body 11 generates a log which is history information. The generated log is stored in the RAM 22 or the HDD 23. The log is usually stored in the HDD 23. In an apparatus not including the HDD 23, the log is stored in the RAM 22. In addition to the log, the HDD 23 stores data of an image read with the scanner function, and the like.

The operation device 12 includes a CPU 30, a ROM 31, a RAM 32, a flash memory 33, a communication I/F 34, a connection I/F 35, and an operation panel 36. The components such as the CPU 30 are connected to one another through a bus 37.

The CPU 30 controls operations of the entire operation device 12 and performs processes such as a function switching process. The ROM 31 or the flash memory 33 stores programs with which the CPU 30 performs the aforementioned processes, an OS, and so on.

The RAM 32 provides a work area for the CPU 30. Thus, the CPU 30 reads the programs or the like stored in the ROM 31 or the flash memory 33 to the RAM 32 and executes the programs to implement the aforementioned processes. The ROM 31 or the flash memory 33 also stores setting values of conditions related to image processing, and so on.

The communication I/F 34 uses, for example, Near Field Communication (NFC), Bluetooth®, or the like to establish a connection to and perform short-range communication with a communication terminal such as a smartphone. The connection I/F 35 is an interface for connection to the communication channel 13.

The operation panel 36 is a touch panel in which a liquid crystal display and a touch detector including transparent electrodes are integrated. The operation panel 36 receives an input of various kinds of information based on a touch operation by a user and displays the input information. The information to be displayed includes information corresponding to a received input, information indicating an operation state of the MFP 10, and information indicating a set state or the like.

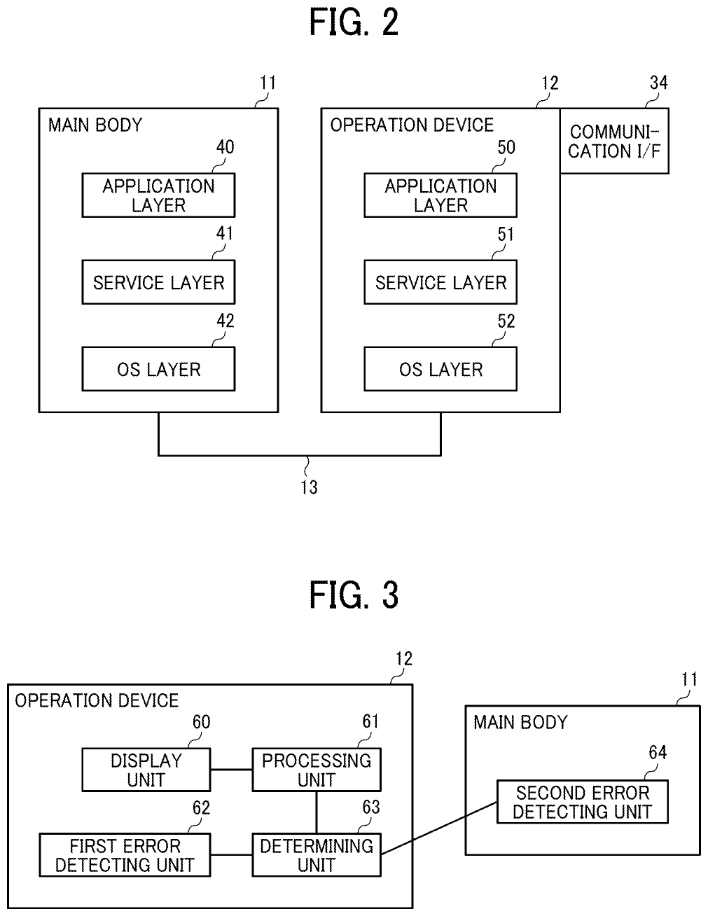

FIG. 2 is a diagram illustrating an example of a software configuration of the MFP 10. The main body 11 of the MFP 10 includes an application layer 40, a service layer 41, an OS layer 42. The operation device 12 includes an application layer 50, a service layer 51, and an OS layer 52. Both the main body 11 and the operation device 12 have a hierarchical structure.

The real entities of the application layer 40, the service layer 41, and the OS layer 42 of the main body 11 are the programs stored in the ROM 21 or the HDD 23. As a result of the CPU 20 executing these programs, the various functions such as the copy function can be provided.

Applications included in the application layer 50 of the operation device 12 cause hardware resources included in the operation device 12 to operate, and consequently provide predetermined functions. The applications included in the application layer 50 include an application that provides a user interface (UI) function for operations and display related to functions of the main body 11, that is, the copy function and the like. The service layer 51 is different from the service layer 41 of the main body 11 in the type of a receivable operation request.

FIG. 3 is a block diagram illustrating a first example of a functional configuration of the MFP 10. The MFP 10 includes, as functional units, a display unit 60, a processing unit 61, a first error detecting unit 62, a determining unit 63, and a second error detecting unit 64. The operation device 12 includes the display unit 60, the processing unit 61, the first error detecting unit 62, and the determining unit 63. The main body 11 includes the second error detecting unit 64.

Each of the aforementioned functional units can be implemented by one or more processing circuits or circuitry. Here, the term “processing circuit or circuitry” encompasses a processor (the CPU 20 or 30) programmed to execute each function based on software, such as a processor implemented by an electronic circuit, and devices, such as an application specific integrated circuit (ASIC), a digital signal processor (DSP), a field programmable gate array (FPGA), and circuit modules of the related art designed to execute each function.

The display unit 60 performs a drawing process on the operation panel 36. The processing unit 61 performs processing of a screen to be displayed on the operation panel 36. The processing of a screen is switching of a screen or the like, and includes arranging another screen over a certain screen or making the current screen transparent. The first error detecting unit 62 detects an error that has occurred in the operation device 12. The first error detecting unit 62 issues a notification about a type of the detected error. The determining unit 63 determines an urgency level of the detected error and issues a notification about a determined result.

The second error detecting unit 64 detects an error that has occurred in the main body 11.

The processing unit 61 issues, to the display unit 60, a request for a drawing process of a panel-touch-disabled-mode screen to disable an operation on the screen in accordance with an instruction from a user. In response to the request for the drawing process from the processing unit 61, the display unit 60 generates the panel-touch-disabled-mode screen and displays the generated screen on the foreground of the operation panel 36.

In response to receipt of the notification about the type of the error from the first error detecting unit 62 or the second error detecting unit 64, or both of the first error detecting unit 62 or the second error detecting unit 64, after the panel-touch-disabled-mode screen is displayed, the determining unit 63 determines the urgency level of the error based on the notified type and issues a notification about the occurrence of the error and the determined result to the processing unit 61.

In response to the notification about the occurrence of the error, the processing unit 61 issues, to the display unit 60, a request to display an error dialog as an error screen on the operation panel 36 and subsequently arrange a predetermined screen on the foreground. In response to this request, the display unit 60 performs a drawing process of the error dialog on the operation panel 36 and subsequently draws and arranges the predetermined screen.

The display unit 60 displays the error dialog and subsequently displays the predetermined screen on the foreground, and thus can immediately prohibit a user from performing an operation on the error dialog.

The predetermined screen may be any screen that disables an operation on the error dialog by the user. In one embodiment, the predetermined screen is a black screen, for example. Thus, the predetermined screen is a screen having substantially the same function as the panel-touch-disabled-mode screen. Note that since disabling a user operation is intended, a response condition of a button included in the error dialog may be changed and the button may be grayed out so as not to be pressed. Alternatively, the button included in the error dialog may be hidden.

In accordance with the notified determined result from the determining unit 63, the processing unit 61 issues, to the display unit 60, a request to switch the screen. That is, if the urgency level of the error is determined to be high, the processing unit 61 issues a request to hide the predetermined screen or the like. If the processing unit 61 has issued a request to gray out the button in the error dialog or hide the button in the error dialog, the processing unit 61 issues a request to restore the original display (a state in which pressing of the button is permitted). In response to this request, the display unit 60 hides the predetermined screen or like to permit an operation on the error dialog.

Since the predetermined screen is displayed on the foreground, the panel touch disabled state is maintained for an error of a low urgency level. An operation on the error dialog is permitted for an error of a high urgency level.

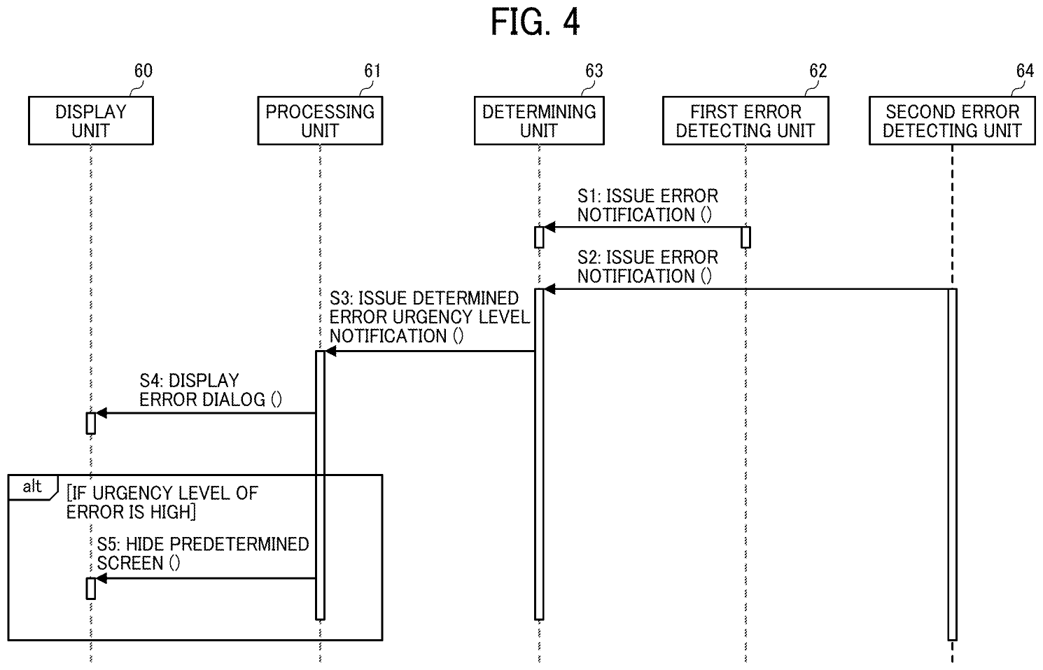

FIG. 4 is a sequence diagram illustrating a first example of a process to be performed in response to occurrence of an error after an operation on a screen is disabled. An error is detected by the first error detecting unit 62 or the second error detecting unit 64, or both of the first error detecting unit 62 and the second error detecting unit 64. In the example illustrated in FIG. 4, the first error detecting unit 62 detects an error, and subsequently the second error detecting unit 64 detects an error.

The error to be detected by the first error detecting unit 62 of the operation device 12 is a software operation anomaly or the like. The error to be detected by the second error detecting unit 64 of the main body 11 is an anomaly in a fixing system, a startup failure of the engine 26, or the like.

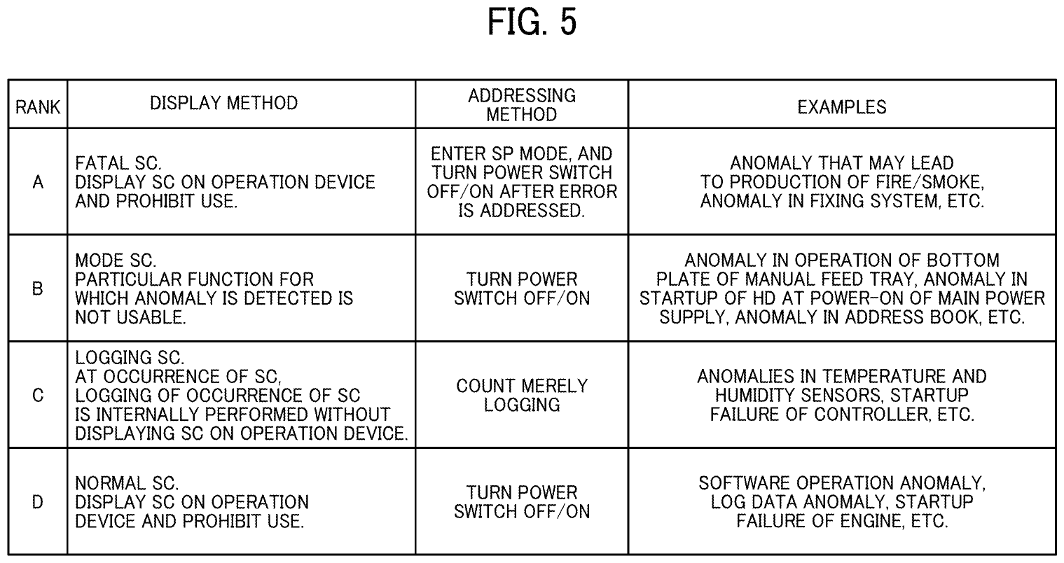

The first error detecting unit 62 and the second error detecting unit 64 each issue, to the determining unit 63, a notification about the occurrence of the error and the type of the error (S1 and S2). The determining unit 63 determines the urgency level of the error based on the type of the error with reference to a table illustrated in FIG. 5.

The urgency level of the error will be described with reference to FIG. 5. The urgency level of the error is an urgency rank determined in accordance with the degree of urgency and is ranked with A to D, for example. In FIG. 5, the urgency level is ranked, but not limited to, with four steps.

The rank A is the highest rank and is set for fatal anomalies. Such anomalies include an anomaly that may lead to production of fire/smoke and an anomaly in the fixing system as recited as examples.

The rank B is the next highest rank to the rank A and is set for anomalies of hardware or the like that are not fatal but are to be used to implement each function. Such anomalies include an anomaly in an operation of a bottom plate of a manual feed tray, an anomaly in the startup of a hard disk (HD) at power-on of a main power supply, and an anomaly in an address book as recited as examples.

The rank C is the third highest rank subsequent to the rank B and is set for other hardware anomalies. Such anomalies include anomalies in temperature and humidity sensors and a startup failure of a controller as recited as examples.

The rank D is the lowest rank and is set for software and data anomalies. Such anomalies include a software operation anomaly, a log data anomaly, and a startup failure of the engine as recited as examples.

Each rank is associated with a display method on the operation panel 36 and an error-addressing method. This allows the processing unit 61 to switch the screen on the operation panel 36 based on the notified rank and the display method associated with the rank. This also allows a user or a service person (maintenance person) to address the error based on the addressing method associated with the rank. In the table, the term “SC” refers to a service call which is a function for automatically issuing a report to a call center in response to detection of a fault. The term “SP mode” refers to a special mode to be used by the service person for maintenance, inspection, and adjustment.

Referring again to FIG. 4, the determining unit 63 determines one of the ranks as the urgency level of the error, and issues a notification about the rank as a determined error urgency level notification (S3). The processing unit 61 receives the notification from the determining unit 63 and issues, to the display unit 60, a request to display the error dialog (S4). In response to the request from the processing unit 61, the display unit 60 displays the error dialog. The processing unit 61 issues, to the display unit 60, a request to subsequently arrange the predetermined screen on the foreground. In response to the request from the processing unit 61, the display unit 60 arranges the predetermined screen on the foreground.

In accordance with the notified rank, the processing unit 61 can issue a request to perform a process of hiding the predetermined screen or the like to permit an operation on the error dialog. For example, if the notified rank is the rank A, the processing unit 61 can issue a request to hide the predetermined screen or the like.

In the sequence illustrated in FIG. 4, the processing unit 61 issues a request to hide the predetermined screen if the urgency level of the error is high (S5). In response to this request, the display unit 60 erases the predetermined screen to hide the predetermined screen.

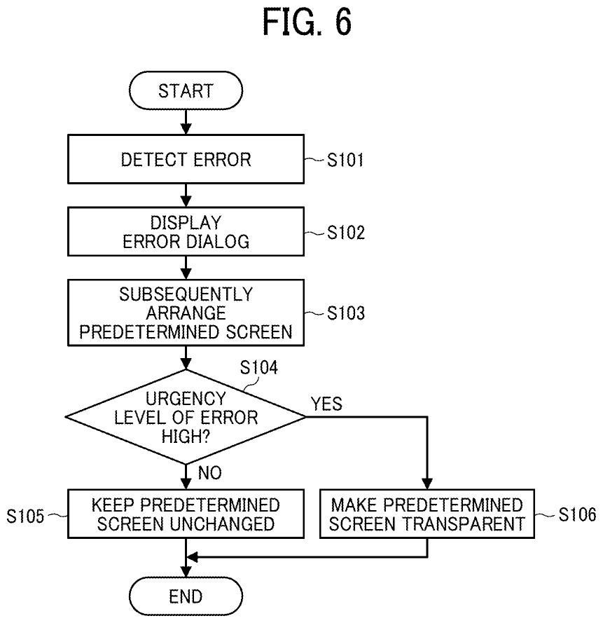

With reference to FIGS. 6 to 8, the description is given of a process of making the predetermined screen transparent to permit a touch on an underlying screen in the case where the urgency level of the error is high. FIG. 6 is a flowchart illustrating an example of the process of making the predetermined screen transparent to permit a touch on an underlying screen in the case where the urgency level of the error is high. In response to the user selecting a panel touch disabled mode, the process starts from step S100. In step S101, the first error detecting unit 62 or the second error detecting unit 64 (or each of the first error detecting unit 62 and the second error detecting unit 64) detects an error.

In step S102, the display unit 60 displays the error dialog in response to the request from the processing unit 61. At this time, the error dialog is arranged on the foreground relative to the panel-touch-disabled-mode screen and is in a user operation permitted state.

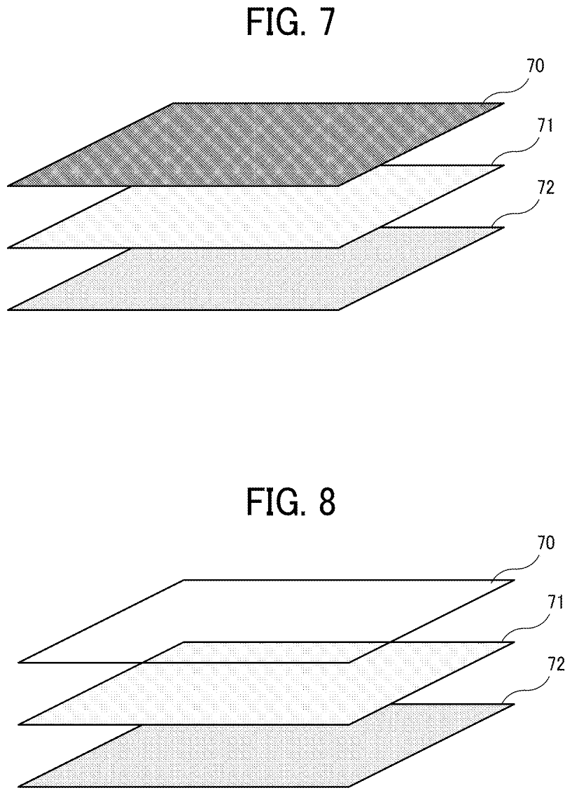

Accordingly, in step S103, the display unit 60 subsequently arranges the predetermined screen on the foreground in response to the request from the processing unit 61. The predetermined screen is, for example, a black screen so as not to permit an operation on the error dialog as illustrated in FIG. 7. On the screen of the operation panel 36, an error dialog 71 appears over a panel-touch-disabled-mode screen 72, and a predetermined screen 70 is arranged over the error dialog 71. That is, the predetermined screen 70 covers the error dialog 71. The predetermined screen 70 may have any size to cover the error dialog 71, that is, may have the same size as the error dialog 71 or a larger size than the error dialog 71.

Referring again to FIG. 6, in step S104, the processing unit 61 determines whether the urgency level of the error is high based on the rank determined by the determining unit 63. If the urgency level of the error is low, the process proceeds to step S105, in which the predetermined screen 70 is kept arranged on the foreground as illustrated in FIG. 7. Thus, the user is not permitted to perform an operation on the error dialog.

On the other hand, if the urgency level of the error is high, the process proceeds to step S106, in which the predetermined screen 70 is made transparent from black as illustrated in FIG. 8 to permit an operation on the error dialog 71.

In the example hitherto described, a setting is made such that the predetermined screen is hidden or made transparent in the case where the urgency level of the error is a predetermined rank or higher. However, the user may set whether to hide the predetermined screen or make the predetermined screen transparent, the rank, or the like. This allows customization according to a desired usage of the user.

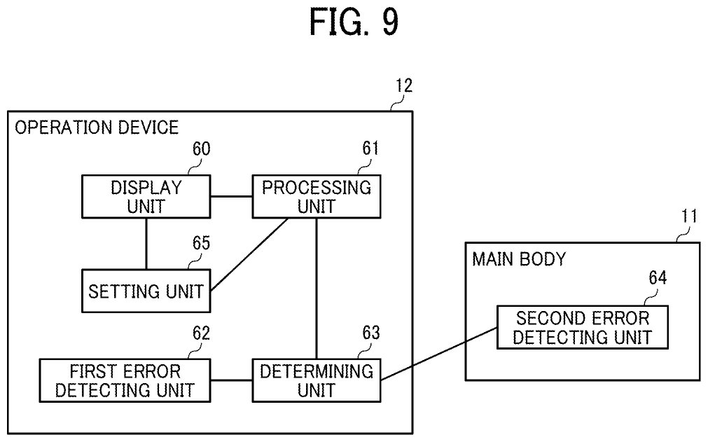

FIG. 9 illustrates a second example of the functional configuration of the MFP 10 that allows the user to set a behavior to be performed in response to the occurrence of an error when the panel-touch-disabled-mode screen is displayed.

The main body 11 includes the second error detecting unit 64. The operation device 12 includes the display unit 60, the processing unit 61, the first error detecting unit 62, and the determining unit 63. In the example illustrated in FIG. 9, the operation device 12 further includes a setting unit 65.

Since the display unit 60, the processing unit 61, the first error detecting unit 62, the determining unit 63, and the second error detecting unit 64 are already described, the description thereof is omitted here. In accordance with an input by a user, the setting unit 65 sets a behavior to be performed in response to the occurrence of an error when the panel-touch-disabled-mode screen is displayed. That is, the setting unit 65 sets a switching condition for switching display of the screen. The switching condition includes the urgency level.

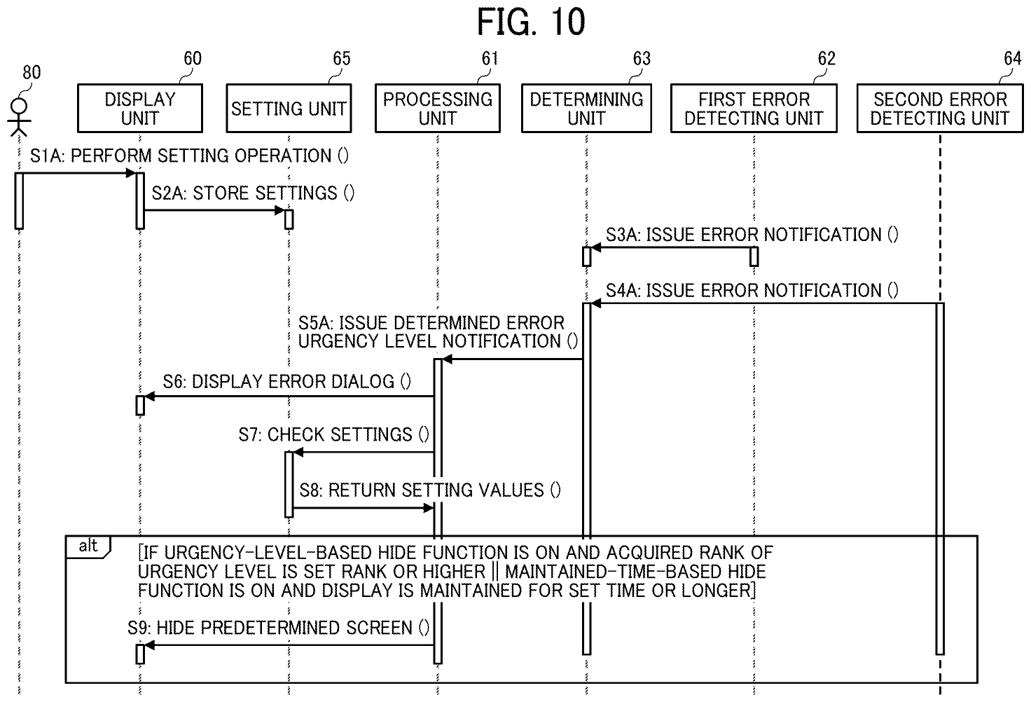

FIG. 10 is a sequence diagram illustrating a second example of the process to be performed in response to occurrence of an error after an operation on a screen is disabled. A user 80 performs a setting operation about the behavior on the display unit 60 (S1A). The display unit 60 instructs the setting unit 65 to store the content set by the setting operation of the user 80 (S2A).

An error is detected by the first error detecting unit 62 or the second error detecting unit 64, or both of the first error detecting unit 62 and the second error detecting unit 64. Also in the example illustrated in FIG. 10, the first error detecting unit 62 detects an error, and subsequently the second error detecting unit 64 detects an error.

The first error detecting unit 62 and the second error detecting unit 64 each issue, to the determining unit 63, a notification about the occurrence of the error and the type of the error (S3A and S4A). The determining unit 63 determines the urgency level of the error based on the type of the error with reference to the table illustrated in FIG. 5.

The determining unit 63 determines one of the ranks in the table illustrated in FIG. 5 as the urgency level of the error, and issues a notification about the rank as a determined error urgency level notification (S5A). The processing unit 61 receives the notification from the determining unit 63 and issues, to the display unit 60, a request to display the error dialog (S6). In response to the request from the processing unit 61, the display unit 60 displays the error dialog. The processing unit 61 issues, to the display unit 60, a request to subsequently arrange the predetermined screen on the foreground. In response to the request from the processing unit 61, the display unit 60 arranges the predetermined screen on the foreground.

The processing unit 61 issues, to the setting unit 65, a request to acquire the content of the settings currently set (S7). In response to the request from the processing unit 61, the setting unit 65 returns the content of the settings (S8).

In accordance with the received content of the settings, the processing unit 61 issues a request to hide the predetermined screen or the like (S9). The processing unit 61 may issue a request to perform a process of making the predetermined screen transparent to permit a touch on an underlying screen. Consequently, an operation on the error dialog is permitted.

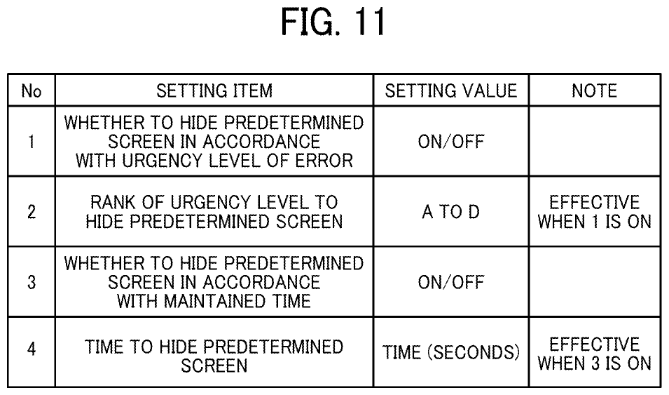

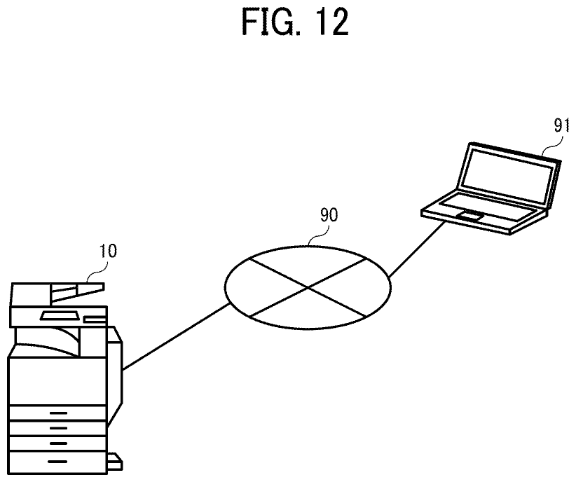

FIG. 11 is a table for describing content of settings of the switching condition settable by the user 80. For example, the user 80 can set settings for four items. The items are (1) whether to hide the predetermined screen in accordance with the urgency level of the error, (2) the rank of the urgency level, (3) whether to hide the predetermined screen in accordance with a maintained time, and (4) a maintained time up until the predetermined screen is hidden.

The items (1) and (2) are associated with each other, and the items (3) and (4) are associated with each other. The item (2) is settable when the item (1) is set to ON. The item (4) is settable when the item (3) is set to ON. This content of the settings is content (setting values) held by the setting unit 65.

In the example illustrated in FIG. 11, whether to hide the predetermined screen is settable in accordance with the urgency level of the error. However, whether to make the predetermined screen transparent may be settable.

FIG. 12 is a diagram illustrating an example of a configuration of an information processing system according to an embodiment of the present disclosure. The description has been given using the MFP 10 including the main body 11 and the operation device 12 as an example. However, the screen is switchable in accordance with the urgency level of the error similarly in a system including two or more apparatuses such as a PC 91 serving as a first apparatus and the MFP 10 serving as a second apparatus. The PC 91 includes the functions of the operation device 12 via a network 90, for example.

That is, the MFP 10 is regarded as the main body 11 and the PC 91 is regarded as the operation device 12. An error in the MFP 10 or the PC 91 (or both of the MFP 10 and the PC 91) is detected, the error dialog is displayed on a screen of the PC 91, and the predetermined screen is arranged on the foreground. Then, whether the urgency level of the error is high is determined. If the urgency level is low, the predetermined screen is maintained. If the urgency level is high, the predetermined screen is hidden or made transparent to permit an operation on the error dialog.

Also in this case, the user is permitted to set a behavior to be performed in response to the occurrence of an error. Instead of hiding the predetermined screen or the like, the response condition of the button in the error dialog may be changed or the button may be hidden without displaying the predetermined screen on the foreground. In one embodiment, the processing unit 61 performs these processes. The processing unit 61 changes the response condition and requests the display unit 60 to hide the button.

The two apparatuses included in the information processing system are not limited to the MFP 10 and the PC 91, and may be a printer and a PC, a projector and a PC, or the like as long as at least one of the apparatuses includes an operation panel. The information processing system is not limited to a system including two apparatuses and may include three or more apparatuses.

The description has been given of the case where the predetermined screen is arranged on the foreground after the error dialog is displayed. However, before the predetermined screen is arranged on the foreground, the urgency level of the error may be determined. If the urgency level of the error is high, the error dialog alone may be displayed without the predetermined screen to permit an operation on the error dialog. If the urgency level of the error is low, the predetermined screen is arranged on the foreground.

As described above, the apparatus, the system, the method, and the program according to the embodiments of the present disclosure successfully make an error of a high urgency level noticeable. An erroneous operation against a user's intention regardless of no urgency may be avoided for an error of a low urgency level. On the other hand, since an error of a high urgency level has the urgency and a quick operation is desired, the predetermined screen arranged on the foreground relative to the error dialog is hidden or the like to permit an operation.

The present disclosure has been described as an information processing apparatus, an image processing apparatus, an information processing system, an information processing method, and a program in the embodiments above. However, the present disclosure is not limited to the embodiments described above, and modifications such as another embodiment, addition, alteration, and deletion may be made within a scope conceivable by the person skilled in the art. Each embodiment is within the scope of the present disclosure as long as the embodiment provides the operations and advantageous effects of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising
circuitry configured to:
disable an operation on a screen displayed on a display; and
switch display of the screen in accordance with an urgency level of an error in response to occurrence of the error after the operation is disabled.

2. The information processing apparatus according to claim 1, wherein the circuitry is configured to:
display an error screen on the display in response to the occurrence of the error, the error screen including a predetermined screen; and
hide the predetermined screen or make the predetermined screen transparent, in accordance with the urgency level of the error.

3. The information processing apparatus according to claim 1, wherein the circuitry is configured to:
display an error screen on the display in response to the occurrence of the error, the error screen including a button; and
change, in accordance with the urgency level of the error, a response condition under which the button responds.

4. The information processing apparatus according to claim 1, wherein the circuitry is configured to:
display an error screen on the display in response to the occurrence of the error, the error screen including a button; and
hide the button, in accordance with the urgency level of the error.

5. The information processing apparatus according to claim 1, wherein the circuitry is configured to:
set a switching condition for switching display of the screen, the switching condition including the urgency level; and
switch the screen in accordance with the switching condition that is set.

6. The information processing apparatus according to claim 1, further comprising
an engine to execute an image processing function.

7. An information processing system comprising:
a display to display a screen; and
circuitry configured to
disable an operation on a screen displayed on the display, and
switch display of the screen in accordance with an urgency level of an error in response to occurrence of the error after the operation is disabled.

8. The information processing system according to claim 7, further comprising:
a first apparatus including
the display to display the screen that receives an operation, and
the circuitry; and
one or more second apparatuses to implement one or more functions operated by the first apparatus via the screen.

9. An information processing method comprising:
disabling an operation on a screen displayed on a display; and
switching display of the screen in accordance with an urgency level of an error in response to occurrence of the error after the operation is disabled.

10. A non-transitory recording medium storing a plurality of instructions which, when executed by one or more processors, causes the processors to perform the information processing method of claim 9.
